(19) United States
(12) Patent Application Publication
(10) Pub. No.: US 2009/0290592 A1
(43) Pub. Date: Nov. 26, 2009

(54) RING BUFFER OPERATION METHOD AND SWITCHING DEVICE

(75) Inventors: Toshiteru Konishi, Osaka (JP); Hisaya Ogasawara, Osaka (JP); Hiroyuki Kitajima, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/353,570

(22) Filed: Jan. 14, 2009

(30) Foreign Application Priority Data
Jan. 15, 2008 (JP) 2008-006233

(51) Int. Cl. H04L 12/56

(52) U.S. Cl. 370/412

(57) ABSTRACT

A buffer operation method, for use with a buffer organized as a plurality of sections, two or more continuous ones of the sections being defined as a monitor block, the method including: receiving a data packet and dividing the same into a plurality of divisions; storing the divisions in a given one of the sections; moving, in the case where the given section is behind the monitor block, the monitor block so that a tail end thereof corresponds to the given section; monitoring whether the plurality of divisions required for reassembly of the packet are stored in the monitor block; and transferring, once all the required plurality of divisions are collected in the monitor block, the same from the buffer for subsequent reassembly of the packet.

### CROSS-REFERENCE TO RELATED APPLICATIONS

This application is based upon and claims the benefit of priority of the prior Japanese Patent Application No. 2008-006233, filed on Jan. 15, 2008, the entire contents of which are incorporated herein by reference.

### BACKGROUND

1. Field

The embodiments discussed herein are related to a communication system.

2. Description of Related Art

FIG. 11 depicts the function of a conventional switching node according to the Related Art. FIG. 12 depicts the manner in which a conventional switching node 9 handles a packet according to the Related Art.

In the related art, the data for communication are exchanged in the packet exchange network as described below.

The device at the transmitting end divides the data into a plurality of packets, and sends out the packets to the packet exchange network by designating the device at the receiving end as an address. Then, each packet is delivered to the device at the receiving end by being relayed through various switching nodes. The device at the receiving end assembles each packet and restores the original data.

The switching node relays not only the packets exchanged between the device set described above but also between other sets of devices. The switching node, therefore, as illustrated in FIG. 11, relays packets of various sizes.

In order to relay the packets at a higher speed, a switching node 9 as illustrated in FIG. 12 has been proposed.

The switching node 9 includes a plurality of switch fabrics 92. An input traffic control unit (Ingress TM) 91 divides the input packet PT into a plurality of segments SM having a substantially uniform size, and distributes these segments SM substantially uniformly among the plurality of switch fabrics 92. Each switch fabric 92 switches the segment SM distributed thereto to the output traffic control unit (Egress TM) 93 connected to the relay destination node. Then, the output traffic control unit 93, by assembling the segments SM sent from switching fabric 92, regenerates the packet PT and transmits it to the relay destination node.

As described above, the packets PT of various sizes are divided into substantially uniform segments SM and distributed substantially uniformly among the plurality of switching fabrics 92 for the switching operation, thereby reducing the idling time. In this case, the idling time can be reduced more than in the case where the packet PT is switched without being divided into segments SM. Thus, the operation is possible with a smaller idling of the switching fabrics 92. As a result, the packet PT can be relayed at higher speed.

Further, Japanese Patent Application Laid-Open No. 10-98475 discloses a method of buffer management in the exchange system. Japanese Patent Application Laid-Open No. 7-273771, on the other hand, discloses a method of monitoring whether cells in the declaration amount of the communication band have been sent or not.

### SUMMARY

An embodiment of the present invention provides a buffer operation method, wherein the buffer being organized as used for assembling the data divided into a plurality of division data is separated into a plurality of sections, and two or more continuous ones of the sections are being defined as a monitor block, the method comprising: receiving a data packet and dividing the same into a plurality of divisions; storing the divisions data sent in are stored in a given one of the sections; moving, and in the case where the given section storing the division data is behind the monitor block, the monitor block section is moved so that a the tail end thereof the monitor block corresponds to the given section; monitoring whether the plurality of the divisions data required for data reassembly of the packet are monitored whether they are stored in the monitor block; and transferring, once all the required plurality of the divisions data required for data assembly are collected in the monitor block, the plurality of the division data are called same from the buffer for subsequent reassembly of the packet. to assemble the data.

It is to be understood that both the foregoing general description and the following detailed description are exemplary and explanatory and are not restrictive of the embodiment of invention, as claimed.

### BRIEF DESCRIPTION OF THE DRAWINGS

Embodiments are illustrated by way of example and not limited by the following figures.

FIG. 1 depicts an example of a switching node as a whole according to an example of an embodiment of the present invention;

FIGS. 2A and 2B depict a packet and a segment according to an example of an embodiment of the present invention;

FIG. 3 depicts an output traffic control unit according to an example of an embodiment of the present invention;

FIG. 4 depicts a first circuit group according to an example of an embodiment of the present invention;

FIG. 5 depicts a segment according to an example of an embodiment of the present invention;

FIG. 6 depicts an 8n byte rearrangement unit according to an example of an embodiment of the present invention;

FIGS. 7A, 7B and 7C depict steps of a process for converting a segment SUk to a segment SVk according to an example of an embodiment of the present invention;

FIG. 8 depicts a second circuit group according to an example of an embodiment of the present invention;

FIG. 9 depicts a reorder processing unit according to an example of an embodiment of the present invention;

FIGS. 10A, 10B and 10C depict a reorder buffer and movement therein of a monitor block and an acceptance block according to an example of an embodiment of the present invention;

FIG. 11 depicts the function of a conventional switching node according to the Related Art; and

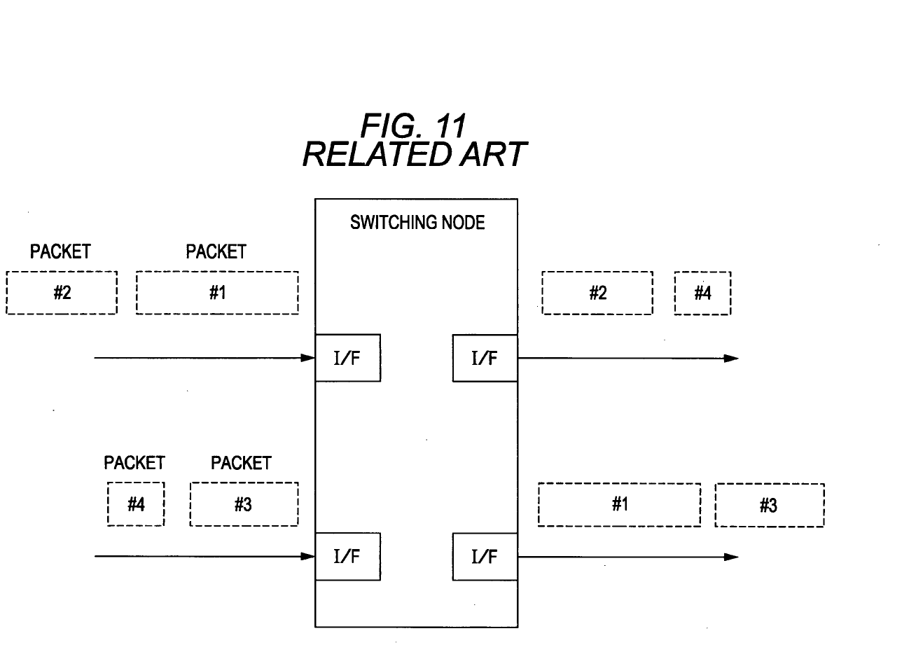

FIG. 12 depicts the manner in which a switching node handles a packet according to the Related Art.

### DESCRIPTION OF EXAMPLE EMBODIMENT(S)

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

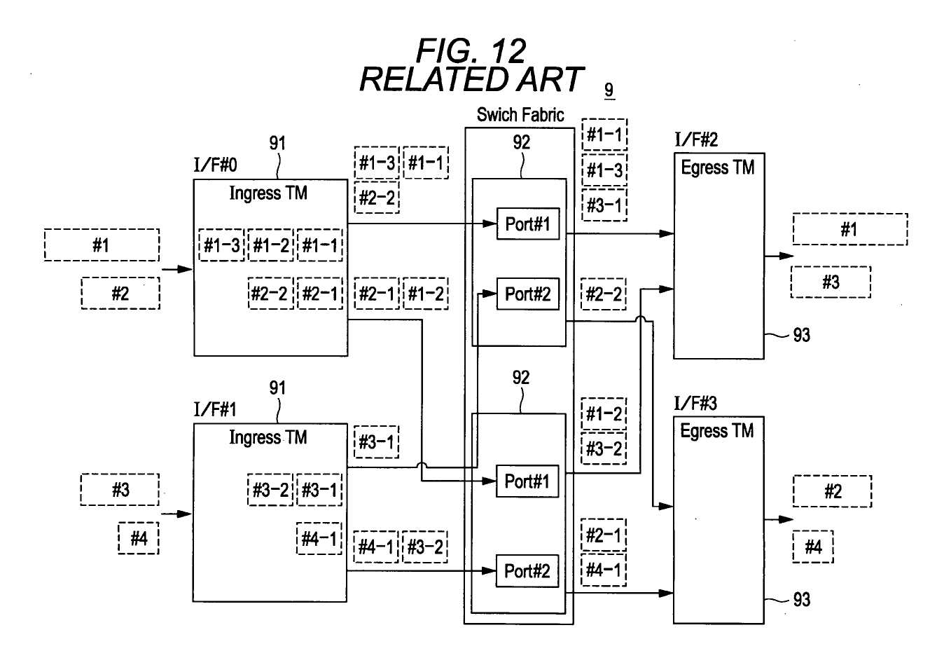

A higher switching operation is required than in the conventional method described with reference to FIG. 12, in which the packet PT is divided into substantially uniform segments SM and distributed substantially uniformly among a plurality of switch fabrics 92.

According to one or more embodiments of the present invention, the packet can be reassembled at a higher speed than in the related art.

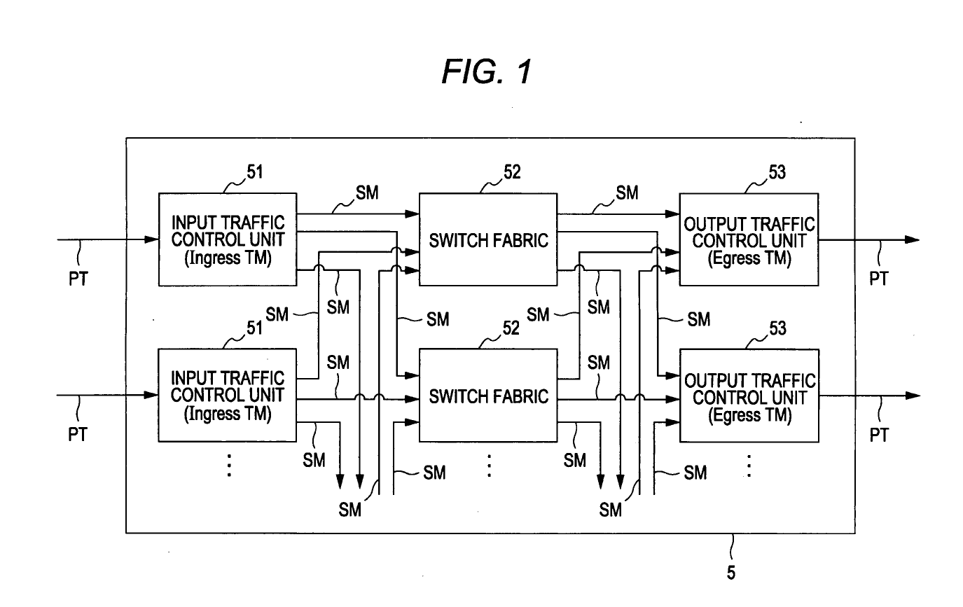

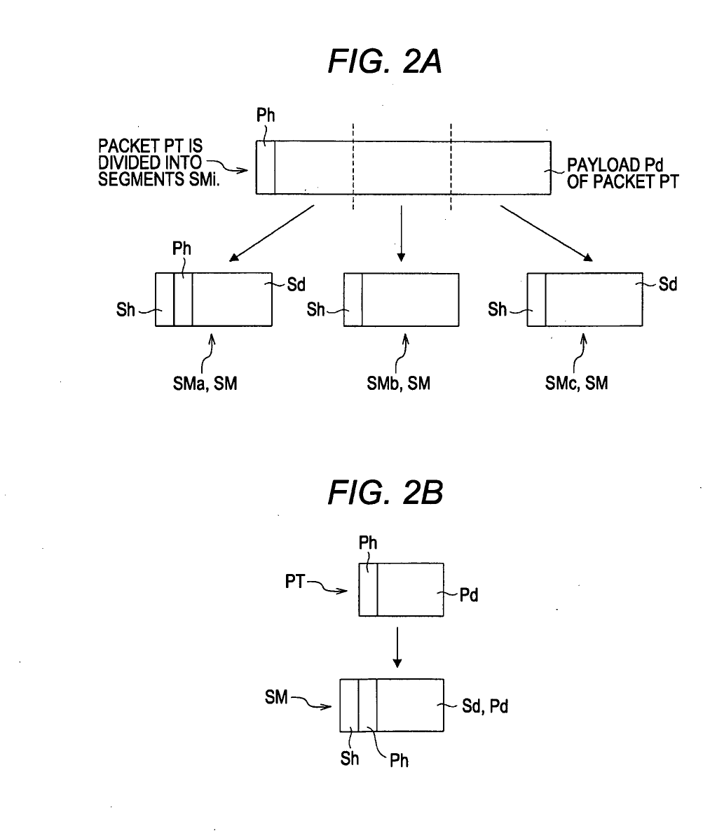

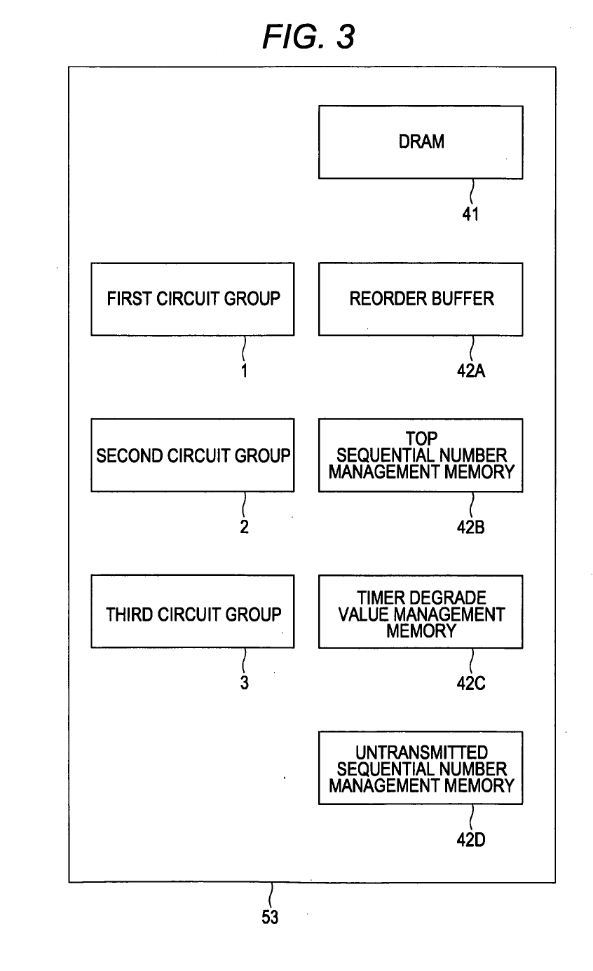

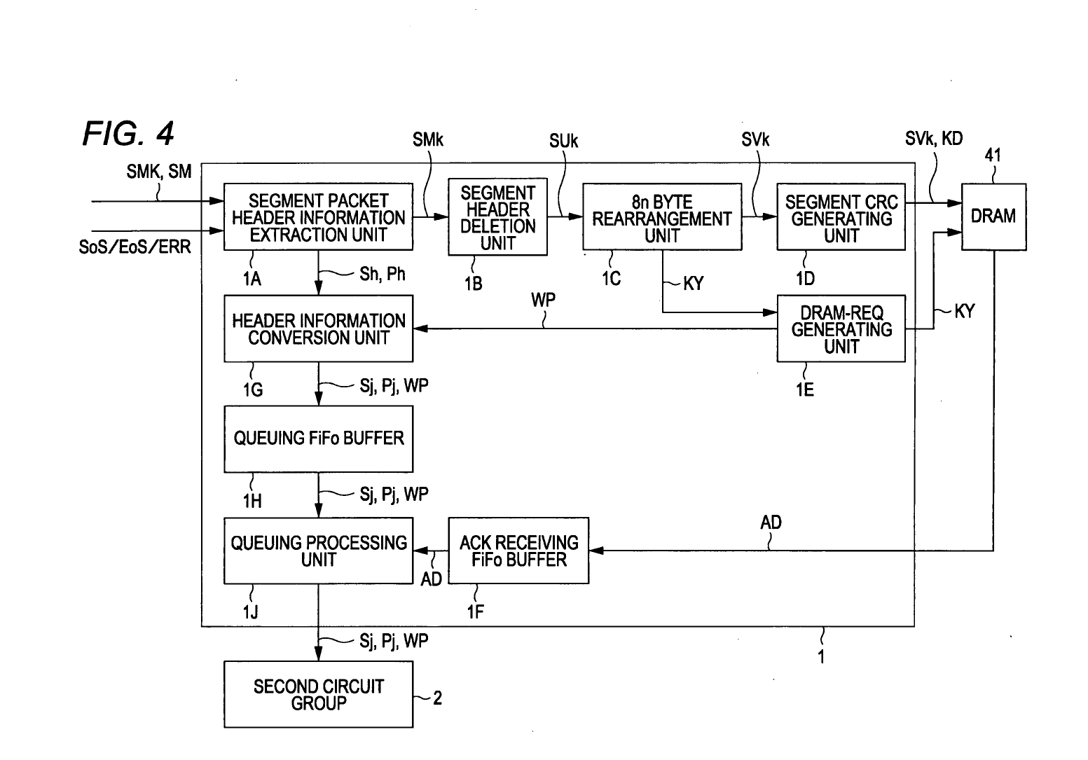

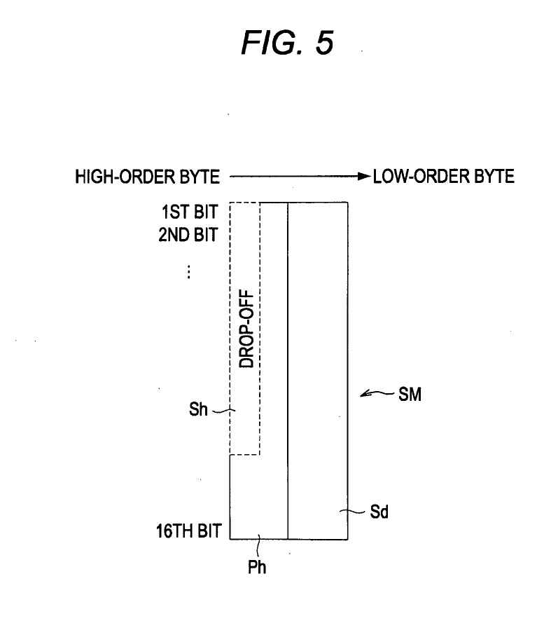

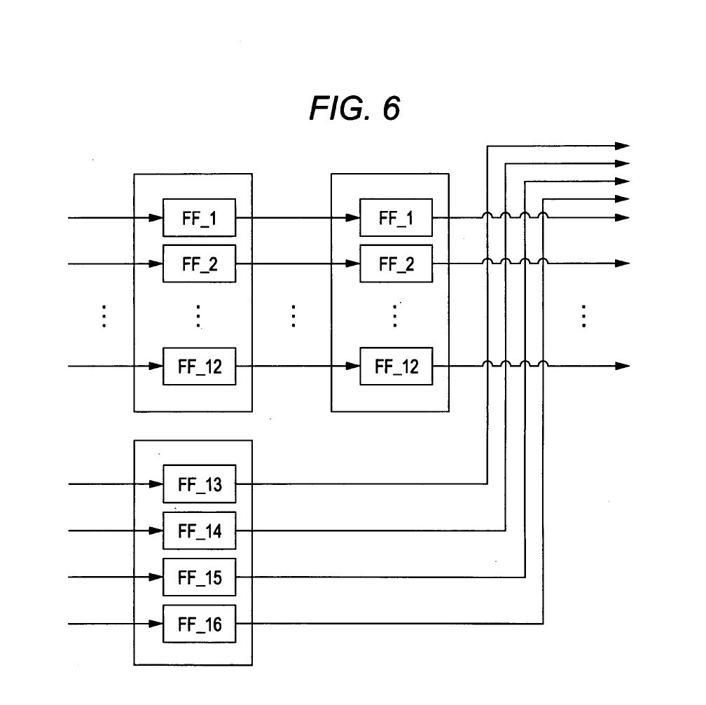

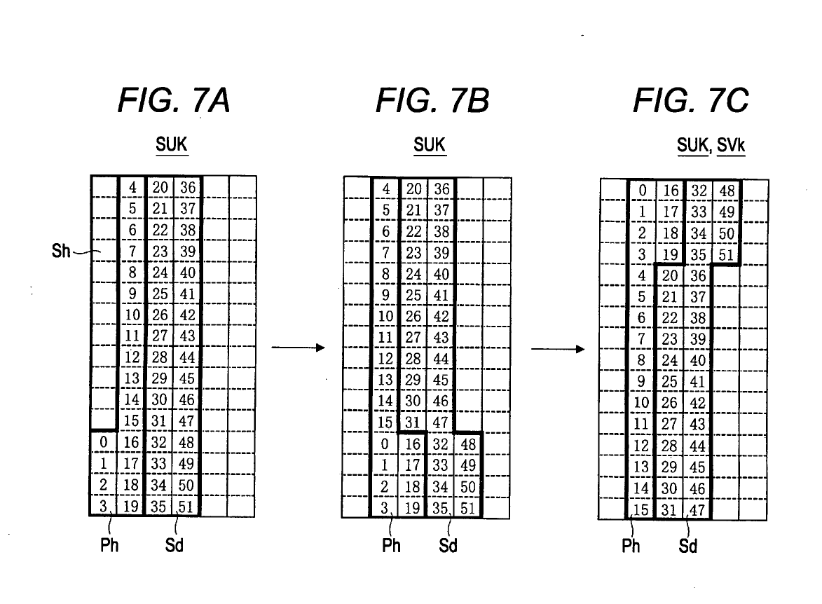

FIG. 1 depicts an example of a switching node 5 as a whole. FIGS. 2A and 2B depict a packet PT and a segment SM. FIG. 3 depicts an output traffic control unit 53. FIG. 4 a first circuit group 1. FIG. 5 depicts a segment SM. FIG. 6 depicts 8n byte rearrangement unit 1C. FIGS. 7A, 7B and 7C depict steps for converting a segment SUk to a segment SVk.

The switching node 5 is a device for switching the packets. The general configuration of the switching node 5 may be, e.g., identical with that of the conventional switching node 9 illustrated in FIG. 12. The switching node 5 in its generation configuration includes, as illustrated in FIG. 1, a plurality of input traffic control units 51, a plurality of switch fabrics 52 and a plurality of output traffic control units 53.

The input traffic control units 51 function similarly to the input traffic control units 91. Specifically, the packet PT transmitted from other nodes is divided into a plurality of segments of a given size as illustrated in FIG. 2A. A segment header Sh is attached to each segment SM.

Each segment SM, i.e., each division of the packet PT, includes a part of the payload Pd of the packet PT. This part is hereinafter referred to as “the payload Sd”. Further, the head segment SM, namely SMa, includes the packet header Ph of the packet PT.

The packet PT, if not more than a given size as illustrated in FIG. 2B, however, may not be divided and constitutes one segment SM.

Incidentally, the word “segment” as used in the field of the network technique may mean LAN (Local Area Network). In other words, the “segment” may mean the network in a range defined by the repeater. According to this embodiment, however, the segment is to be understood as individual data into which the packet PT is divided appropriately.

The segment header Sh of the segment SM includes at least the following attribute information of (A-1) to (A-4). Specifically, (A-1) designates the segment type, i.e. the information indicating the type of the particular segment SM. Specific types include a head segment like the segment SMa of FIG. 2A, an intermediate segment like the segment SMb of FIG. 2A, a tail end segment like the segment SMc of FIG. 2A, and a segment not divided like the segment SM of FIG. 2B. (A-2) designates the segment sequential number indicating how many segments exist from the head before the particular segment. (A-3) designates the segment length, i.e. the bit length (size) of the segment SM. (A-4) designates the inbound card number and the port number (10G port number), i.e. the number of the inbound card and the number of the port to which the particular segment SM is input. These numbers are used in the output traffic control units 53 to judge whether the two segments SM are derived from the same original packet PT or not.

The segments SM are distributed to any of the switch fabrics 52 by the input traffic control units 51.

The switch fabrics 52 also function similarly to the convention switch fabrics 92. Specifically, the segments SM sent from the input traffic control units 51 are transferred to the output traffic control units 53 for communicating with the node representing the next destination of the original packet PT.

The output traffic control units 53 also function basically in similar fashion to the conventional output traffic control units 93. The output traffic control units 53 and the output traffic control units 93 are different from each other in the points described below. (B-1): Although the output traffic control units 93 of the conventional switching node 9 reassemble the packet PT from the segments SM by software control, the output traffic control units 53 of the switching node 5 reassemble the packet PT using only hardware without software control. (B-2): The output traffic control units 53 employ a new operation method of the ring buffer.

The output traffic control units 53 have a circuit module. The circuit module, as illustrated in FIG. 3, is divided mainly into a first circuit group 1, a second circuit group 2 and a third circuit group 3. Further, the output traffic control units 53 include storage units such as a DRAM 41, a reorder buffer 42A, a top sequential number management memory 42B, a timer degrade value management memory 42C and an untransmitted sequential number management memory 42D.

The first circuit group 1, as illustrated in FIG. 4, includes circuit modules such as a segment packet header extraction unit 1A, a segment header deletion unit 1B, an 8n byte rearrangement unit 1C, a segment CRC generating unit 1D, a DRAM-REQ generating unit 1E, an ACK receiving FiFo buffer 1F, a header information conversion unit 1G, a queuing FiFo buffer 1H and a queuing processing unit 1J.

The operation of each part of the first circuit group 1 is explained with reference to a case in which a given segment SMk is input to the first circuit group 1.

The segment packet header extraction unit 1A extracts the segment header Sh from the segment SMk. The packet header Ph is also extracted in the case where the segment SMk is the head segment or the segment is not divided.

The segment packet header extraction unit 1A is supplied with not only the segment SMk but also a signal indicating the timing of the segment head (SoS: Start of Segment), a signal indicating the tail end of the segment (EoS: End of Segment) and a signal indicating an error (ERR). The segment packet header extraction unit 1A, based on these signals, extracts only the segment header Sh or both the segment header Sh and the packet header Ph.

The segment header deletion unit 1B executes the process of deleting the segment header Sh from the segment SMk. By deleting the segment header Sh, a part of the segment SMk drops off. Assuming that the basic processing unit of the first circuit group 1 is 16 bits and the size (bit length) of the segment header Sh is not more than 15 bytes, for example, as illustrated in FIG. 5, several bits of the 16-bit data in the head of the segment SMk drop off. The segment SMk from which the segment header Sh is deleted is hereinafter referred to as “the segment SUk”.

The 8n byte rearrangement unit 1C is formed of multiple flip-flops as illustrated in FIG. 6. In the 8n byte rearrangement unit 1C, as illustrated in FIGS. 7A, 7B and 7C, the 13th to 16th bit data (0 to 3 in FIG. 7A) of the Nth byte data (16-bit data) in the segment SUk are combined with the 1st to 12th bit data (4 to 15 in FIG. 7A) of the (N+1)th byte data (4 to 15 and 0 to 3 in FIG. 7B). Then, the 8n byte rearrangement unit 1C replaces the position of the former with that of the latter (1 to 15 in FIG. 7C) thereby to set the segment SUk in order. The segment SUk set in order by the 8n byte rearrangement unit 1C is hereinafter referred to as “the segment SVk”.

The segment CRC generating unit 1D generates the data (hereinafter referred to as “the inspection data KD”) for CRC (cyclic redundancy check) of the segment SVk. The DRAM-REQ generating unit 1E generates the write request of the segment SVk and the data KY indicating the write address.

The segment SVk, the inspection data KD and the write request data KY are output to the controller of the DRAM 41, so that the segment SV and the inspection data KD are written in the DRAM 41 based on the write request data KY.

The ACK receiving FiFO buffer 1F acquires, from the controller of the DRAM 41, the data (hereinafter referred to as “the ACK data AD”) indicating the completion of the write operation of the segment SVk into the DRAM 41 and temporarily stores it. The ACK receiving FiFO buffer 1F employs the FiFo (first-in first-out) method.

The header information conversion unit 1G converts the segment SMk into the segment header Sh in such a manner as to illustrate, e.g, only the information required for the process in the second circuit group 2 sequentially explained later. The packet header Ph, if included in the segment SMk, is also converted in such a manner as to illustrate, e.g., only the required information. Specifically, the information included in the segment header Sh and the packet header Ph are selected. The segment header Sh and the packet header Ph converted are hereinafter referred to as “the segment header Sj” and “the packet header Pj”, respectively.

Further, the header information conversion unit 1G acquires the address designated by the DRAM-REQ generating unit 1E to the controller of the DRAM 41, i.e. the address (hereinafter referred to as “the write pointer WP”) where the segment SUk is written.

The header information conversion unit 1G then stores the segment header Sj of the segment SMk (SUk), the packet header Pj and the write pointer WP temporarily in the queuing FiFo buffer 1H. The queuing FiFo buffer 1H employs the FiFo method.

In the queuing processing unit 1J, the segment header Sj, the packet header Pj and the write pointer WP stored in the queuing FiFo buffer 1H are output to the second circuit group 2 on FiFo basis each time the ACK data AD is output from the ACK receiving FiFO buffer 1F on FiFo basis. As a result, the segment header Sj, the packet header Pj and the write pointer WP can be output to the second circuit group 2 at the timing after the segment SUk is written in the DRAM 41. The data including the segment header Sj, the packet header Pj and the write pointer WP is hereinafter referred to as “the segment attribute data SZ”.

The segments SM other than the segment SMk are similarly processed by the first circuit group 1. Then, the segment attribute data SZ of each segment SM is generated.

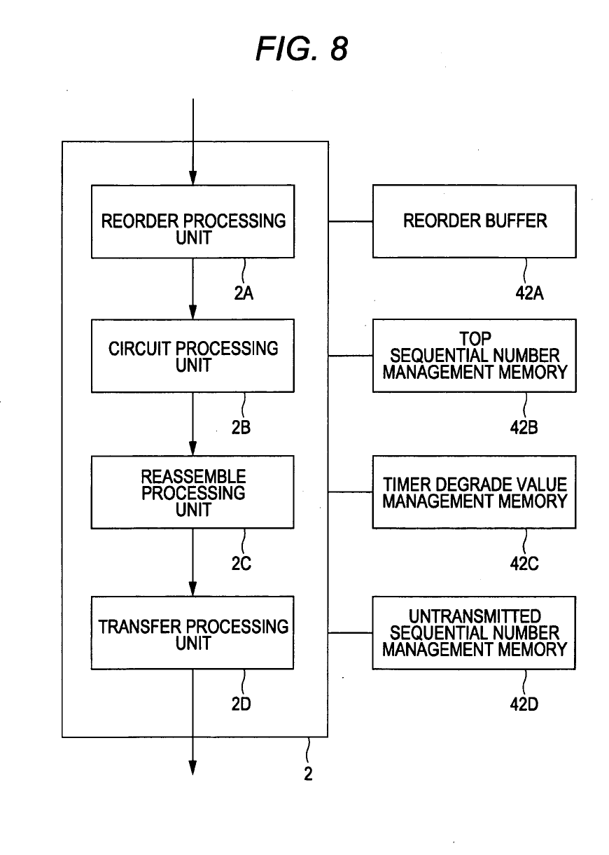

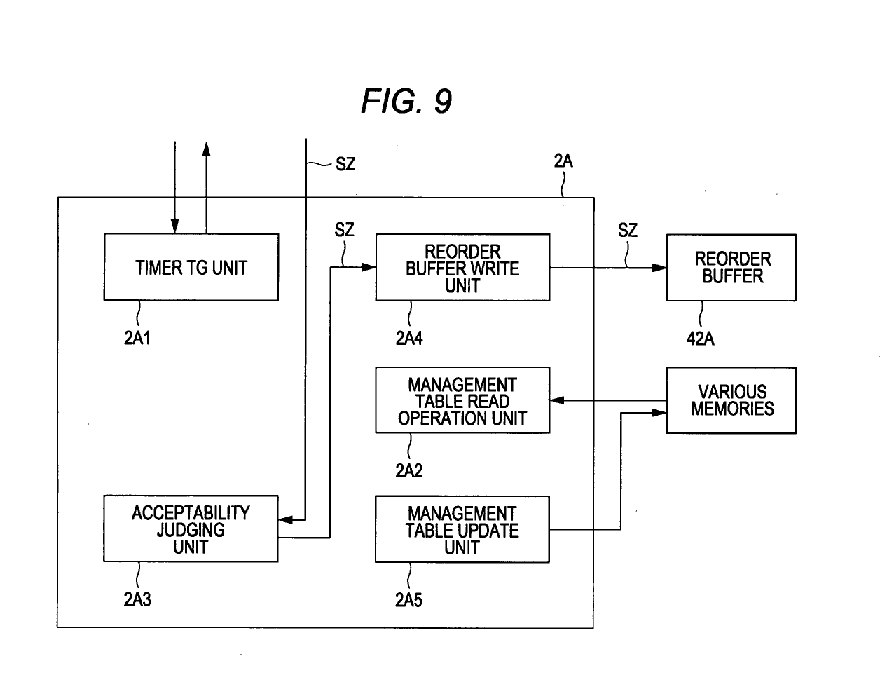

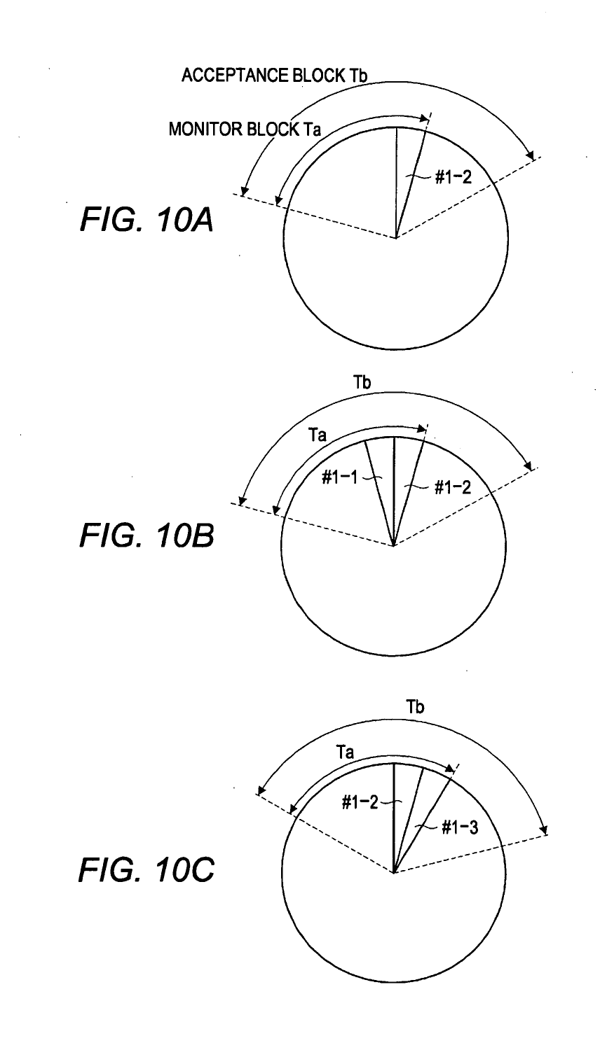

FIG. 8 depicts a second circuit group 2. FIG. 9 depicts a reorder processing unit 2A. FIGS. 10A, 10B and 10C are depict movement of a monitor block Ta and an acceptance block Tb within the reorder buffer 42A.

As illustrated in FIG. 8, the second circuit group 2 illustrated in FIG. 3 includes a reorder processing unit 2A, a circuit processing unit 2B, a reassemble processing unit 2C and a transfer processing unit 2D.

The reorder processing unit 2A, as illustrated in FIG. 9, includes a timer TG unit 2A1, a management table read operation unit 2A2, an acceptability judging unit 2A3, a reorder buffer write unit 2A4 and a management table update unit 2A5.

The timer TG unit 2A1 acquires the condition signal from each part and, based on this condition signal, sends out a process timing signal to particular part. Upon acquisition of a queuing process completion signal from the queuing processing unit 1J of the first circuit group 1, for example, a signal requesting to read the segment attribute data SZ is sent out to the read queuing processing unit 1J of the first circuit group 1.

The management table read operation unit 2A2 reads the data required for the process at each part of the reorder processing unit 2A from each buffer or memory.

The acceptability determining unit 2A3 judges whether the segment attribute data SZ sent from the first circuit group 1 can be accepted or not. In the case where a signal indicating that an error is included in the original segment SM of the segment attribute data SZ is input, for example, the segment attribute data SZ is determined as unacceptable. Otherwise, the segment attribute data SZ is determined acceptable.

The reorder buffer write unit 2A4 writes the segment attribute data SZ in the reorder buffer 42A in the case where the acceptability determining unit 2A3 judges that the segment attribute data SZ sent from the first circuit group 1 can be accepted. The reorder buffer 42A is a ring buffer as illustrated in FIGS. 10A, 10B and 10C.

A particular position at which the segment attribute data SZ is written in the reorder buffer 42A is uniquely determined by the port number and the segment sequential number indicated in the segment header Sj including the particular segment attribute data SZ.

Specifically, the reorder buffer write unit 2A4 writes the segment attribute data SZ in the reorder buffer 42A in such a manner that the segment attribute data SZ of the segments SM as divisions of the same packet PT are arranged adjacently to each other in the order of the segment sequential number. Which segment attribute data SZ correspond to the segment SM as a division of the same packet PT can be detected by the port number of each segment attribute data SZ.

The reorder buffer 42A is divided into a plurality of sections. One segment attribute data SZ is stored in each section. Also, the reorder buffer 42A has defined therein two blocks including a plurality of continuous sections, i.e., a monitor block Ta and an acceptance block Tb.

The monitor block Ta is for monitoring the write operation of the segment attribute data SZ used for the assembly process described later.

The acceptance block Tb indicates a block for accepting the segment attribute data SZ sent from the first circuit group 1. Specifically, in the case where the position to write the segment attribute data SZ sent to the reorder buffer write unit 2A4 is other than the acceptance block Tb, the reorder buffer write unit 2A4 discards the segment attribute data SZ without writing in the reorder buffer 42A.

The length of the monitor block Ta and the acceptance block Tb, e.g., is not variable but the position thereof may be variable. Although the monitor block Ta and the acceptance block Tb may have the same head position, the monitor block Ta may be shorter than the acceptance block Tb. In other words, the monitor block Ta may be described as a subset of, or as overlapping with, the acceptance block Tb. Now, the position change of the monitor block Ta and the acceptance block Tb is explained.

In FIG. 10A, the segment attribute data SZ of “#1-2” is stored in the last section of the monitor block Ta.

Next, FIG. 10B illustrates a case in which another segment attribute data SZ (the segment attribute data SZ of “#1-1” is stored in the section before the aforementioned segment attribute data SZ. In this case, the positions of the monitor block Ta and the acceptance block Tb are not changed.

On the other hand, FIG. 10C illustrates a case in which another segment attribute data SZ (the segment attribute data SZ of “#1-3”) is stored in the section after the aforementioned segment attribute data SZ. In this case, the position of the monitor block Ta is changed in such a manner that the tail end of the monitor block Ta represents the section of the particular another segment attribute data SZ. Accordingly, the acceptance block Tb is also changed.

Incidentally, the top sequential number management memory 42B stores the segment sequential number of the head segment SM. In the case where the segment SM is the head segment or is not divided, therefore, the segment sequential number indicated in the segment header Sh of the segment SM is stored. In the case where the segment SM is not the head segment or divided, on the other hand, the segment sequential number indicated in the segment header Sh of the leading one of other segments SM into which the same packet PT are divided.

The timer degrade value management memory 42C stores the time at which the segment SM is input to the second circuit group 2 from the first circuit group 1.

The untransmitted sequential number management memory 42D stores the segment sequential number of the segment SM of the packet PT not yet transmitted (relayed) to the next node.

The data stored in the top sequential number management memory 42B, the timer degrade value management memory 42C and the untransmitted sequential number management memory 42D are appropriately accessed in the process of each part described later.

Returning to FIG. 9, the management table update unit 2A5 updates the table of each buffer or each memory appropriately each time the acceptability determining unit 2A3 judges whether the segment attribute data SZ is acceptable or not.

The circuit processing unit 2B monitors the monitor block Ta in circuit to determine whether the segment attribute data SZ of all the segments SM, i.e., of all the divisions, of the same packet PT are written in the monitor block Ta of the reorder buffer 42A.

The reassembly processing unit 2C accesses the segment attribute data SZ of all the segments SM as the divisions of the same packet PT from the reorder buffer 42A and arranges them in the order of the segment sequential number thereby to reassemble the packet. Since the segment attribute data SZ includes no payload, however, the packet does not yet include the payload at this stage. In the description that follows, the packet assembled by the reassembly processing unit 2C is described as “the packet PS”.

The transfer processing unit 2D transfers (sends out) the packet PS assembled by the reassembly processing unit 2C to the third circuit group 3.

The third circuit group 3 regenerates the packet PT by adding the payload Pd stored in the DRAM 41 to the packet PS. A particular address at which the payload Pd is stored in the DRAM 41 is indicated by the write pointer WP of the segment attribute data SZ. This packet PT is transmitted to the next switching node, etc.

According to this embodiment, the monitor block Ta is set in reorder buffer 42A representing a ring buffer, and the monitor block Ta is monitored as to whether all the data (the segment attribute data SZ) required for reassembly of the packet PT are collected. As a result, the monitor time is shortened and the reassembly can be carried out at higher speed.

Further, in the case where a new segment attribute data SZ is stored before the tail end of the monitor block Ta, the monitor block Ta is not moved, while in the case where the new segment attribute data SZ is stored behind the tail end, on the other hand, the monitor block Ta is moved in such a manner that the tail end represents the particular storage position (section). As a result, the monitor operation can be performed more efficiently.

Furthermore, the acceptance block Tb is defined and the segment attribute data SZ in other than the acceptance block Tb are discarded. Thus, the late arriving segment attribute data SZ can be smoothly discarded.

The whole monitor block Ta may be included in the acceptance block Tb, as explained with reference to FIGS. 10A, 10B and 10C. Alternatively, only a part of the monitor block Ta may be included in the acceptance block Tb. For example, a given number of sections from the head of the monitor block Ta may not be included in the acceptance block Tb. In this case, the monitor block Ta may be longer than the acceptance block Tb. The tail end of the acceptance block Tb, however, is desirably behind the tail end of the monitor block Ta.

The configuration of the whole or each part of the switching node 5, processing operation, processing order and the structure of the data base can be appropriately changed without departing from the spirit of the present invention.

At least one embodiment of the present invention may also be embodied as machine-readable data including executable instructions that are recorded on a machine-readable recording medium. The machine-readable recording medium is any data storage device that can store the data, including the executable instructions, and which can be read by a machine, e.g., a computer system, so as to provide the machine with the executable instructions included in the recorded data for execution. Examples of the machine-readable recording medium include read-only memory (ROM), random-access memory (RAM), CD-ROMs, magnetic tapes, floppy disks, optical data storage devices, etc. The machine-readable recording medium may also be distributed over network coupled computer systems so that the machine-readable code is stored and executed in a distributed fashion.

All examples and conditional language recited herein are intended for pedagogical purposes to aid the reader in understanding the present invention and the concepts contributed by the inventor to furthering the art, and are to be construed as being without limitation to such specifically recited examples and conditions, nor does the organization of such examples in the specification relate to a showing of the superiority and inferiority of the present invention. Although embodiments of the present invention have been described in detail, it should be understood that the various changes, substitutions, and alterations could be made hereto without departing from the spirit and scope of the invention.

What is claimed is:

1. A buffer operation method, the buffer being organized as a plurality of sections, two or more continuous ones of the sections being defined as a monitor block, the method comprising:
receiving a data packet and dividing the same into a plurality of divisions;
storing the divisions in a given one of the sections;
moving, in the case where the given section is behind the monitor block, the monitor block so that a tail end thereof corresponds to the given section;
monitoring whether the plurality of divisions required for reassembly of the packet are stored in the monitor block; and
transferring, once all the required plurality of divisions are collected in the monitor block, the same from the buffer for subsequent reassembly of the packet.

2. A buffer operation method comprising:
organizing the buffer into a plurality of sections;
defining two or more of the sections as a monitor block;
defining an acceptance block as including two or more of the sections and a given part of the monitor block;
receiving a data packet and dividing the same into a plurality of divisions;
determining one amongst the sections in which to store the divisions;
storing the divisions in the determined section in the case where the determined section corresponds to the acceptance block, while otherwise discarding the divisions;
moving the monitor block so that the tail end of the monitor block corresponds to the determined section in the case where the determined section is behind the monitor block;
moving the acceptance block with the movement of the monitor block;
monitoring whether the divisions required for reassembly of the packet are stored in the monitor block; and
transferring, once the required divisions are collected in the monitor block, the same from the buffer for subsequent reassembly of the packet.

3. The buffer operation method according to claim 2,
wherein the head of the monitor block and the head of the acceptance block are defined to be in the same section, and the acceptance block is longer than the monitor block.

4. The buffer operation method according to claim 2,
wherein the length of each division is not larger than a given length.

5. A switching device comprising:
a plurality of packet receiving units to receive packets to be switched;
a plurality of packet dividing units to divide received packets into a plurality of divisions and distribute the same;
a plurality of division data relay units to relay the divisions from the packet dividing units to a plurality of packet transfer units;
the plurality of packet transfer units having a buffer organized into a plurality of sections;
the packet transfer units being operable to determine continuous two or more ones of the sections in the buffer as a monitor block, store the related divisions in a given one of the sections, monitor whether the divisions required for packet reassembly are stored in the monitor block, transfer the required divisions once the same are collected in the monitor block, and reassemble the packet; and
the packet transfer units moving the monitor block, in the case where the given section storing the divisions is behind the monitor block, so that the tail end of the monitor block corresponds to the given section.

6. A switching device comprising a plurality of packet receiving units, a plurality of packet dividing units, a plurality of division data relay units and a plurality of packet transfer units having a buffer;
wherein the packet receiving units receive a packet to be switched,
the packet dividing units divide the packet received by the packet receiving units into a plurality of divisions and distribute the same among the plurality of the division data relay units,
the division data relay units relay the divisions from the packet dividing units to the packet transfer unit, and
the packet transfer unit separates the buffer into a plurality of sections, defines two or more of the sections as a monitor block, defines an acceptance block as including two or more of the sections and a given part of the monitor block, determines the section to store the divisions relayed from the division data relay unit, stores the divisions relayed from the division data relay unit in the determined section in the case where the determined section corresponds to the acceptance block, while discarding the divisions otherwise, moves the monitor block so that the tail end of the monitor block corresponds to the given section storing the divisions in the case where the determined section is behind the monitor block, moves the acceptance block in accordance with the movement of the monitor block, monitors whether the divisions required for packet reassembly are stored in the monitor block, and transfers the divisions required for packet reassembly once all the divisions are collected in the monitor block.

7. The switching device according to claim 6,
wherein the packet transfer units set the head of the monitor block and the head of the acceptance block in the same section, and set the acceptance block to be longer than the monitor block.

8. The switching device according to claim 6,
wherein the packet dividing units divide the packet into divisions that are not longer than a given length.

9. A switching device comprising:
a buffer to store divisions obtained by dividing a packet;
a monitor block definition unit to separate the buffer into sections and to define two or more continuous ones of the sections as a monitor block;
a monitor block comparator unit to compare the section of the divisions stored in the buffer with the section of the monitor block defined by the monitor block definition unit;
a monitor block updating unit to update the monitor block definition unit in such a manner that the section storing the divisions is located at the tail end of the monitor block in the case where the result of comparison by the monitor block comparator unit indicates that the section storing the division data is behind the section of the monitor block; and
a required data judging unit to judge whether the divisions required for reassembling the divisions into a packet are stored in the section defined by the monitor block definition unit,
wherein the divisions are read in the case where the required data judging unit judges that all the required divisions are collected.
